(19) United States
(12) Patent Application Publication
(10) Pub. No.: US 2017/0103335 A1
(43) Pub. Date: Apr. 13, 2017

(54) SUCCESS SUPPORT SYSTEM, INFORMATION PROCESSING DEVICE, METHOD, AND PROGRAM

(71) Applicant: NEC CORPORATION, Tokyo (JP)

(72) Inventor: Yusuke OI, Tokyo (JP)

(73) Assignee: NEC CORPORATION, Tokyo (JP)

(21) Appl. No.: 15/291,547

(22) Filed: Oct. 12, 2016

(30) Foreign Application Priority Data
Oct. 13, 2015 (JP) 2015-202279

(51) Int. Cl. G06N 7/00; G06N 99/00

(52) U.S. Cl. CPC G06N 7/005; G06N 99/005

(57) ABSTRACT

An information processing device includes: a relation information storage unit 11 which stores information indicating relations, each being a relation between a success rate of accomplishing an aimed purpose by a pair of persons or things and attributes of each of the persons or things; and a proposal unit 12 which proposes to change at least some of attributes of at least one of persons or things composing a new pair, based on the information stored in the relation information storage unit.

This application is based upon and claims the benefit of priority form Japanese patent application No.2015-202279, filed on Oct. 13, 2015, the disclosure of which is incorporated herein in its entirety by reference.

### BACKGROUND OF THE INVENTION

1. Field of the Invention

The present invention relates to a success support system, information processing device, success support method, and success support program for supporting an improvement of a success rate of accomplishing an aimed purpose by a pair of persons or things.

2. Description of the Related Art

For example, marriage agencies widely provide matching services of introducing, to members, other members who match the desired conditions input by the members.

In many of these matching services, two types of information input by each member, namely, personal information such as name, age, and education and a condition desired of a partner, are used to search the members for a member who matches the desired condition and extract the matching member.

As an example, Patent Literature (PTL) 1 describes a matching service using each member's attribute and condition indicating an attribute desired of a partner. The matching service described in PTL 1 extracts, for one user, another user whose attribute matches the condition indicating the attribute desired of a partner by the user, and determines whether or not the attribute of the user matches the condition indicating the attribute desired of a partner by the other user. In the case of determining that the attribute of the user matches the condition, the matching service notifies the extracted other user of the attribute of the user.

As another example, PTL 2 describes a matching service of searching for a marriage partner based on scoring data obtained by scoring user-specific data.

### CITATION LIST

### Patent Literature(s)

PTL 1: Japanese Patent Application Laid-Open No. 2011-113546

PTL 2: Japanese Patent Application Laid-Open No. 2007-095011

### SUMMARY OF THE INVENTION

An exemplary object of the present invention is to provide a success support system, information processing device, success support method, and success support program that can realize a more effective matching service.

An information processing device according to the present invention includes: a relation information storage unit which stores information indicating relations, each being a relation between a success rate of accomplishing an aimed purpose by a pair of persons or things and attributes of each of the persons or things; and a proposal unit which proposes to change at least some of attributes of at least one of persons or things composing a new pair, based on the information stored in the relation information storage unit.

A success support system according to the present invention includes: a learning unit which machine-learns relations, each being a relation between a success rate of accomplishing an aimed purpose by any pair of persons or things and attributes of each of the persons or things, using, as learning data, a set of attributes of persons or things of each pair for which a success or failure of the purpose is determinable; a simulation unit which, upon receiving designation of a pair of specific persons or things, analyzes changed the success rates while changing at least some of attributes of at least one of the persons or things of the designated pair, using a result of the learning by the learning unit; a display unit which displays at least: a result of analysis by the simulation unit; and/or modified attribute or attributes among the set of attributes or a contribution of the change to improvement of the success rate identified by the result, which improves the success rate of the designated pair.

A success support method according to the present invention includes proposing, by an information processing device, based on information that is stored in a predetermined storage unit and indicates relations, each being a relation between a success rate of accomplishing an aimed purpose of persons or things and attributes of each of the persons or things, a change of at least some of attributes of at least one of persons or things.

### BRIEF DESCRIPTION OF THE DRAWINGS

FIG. 1 It is a block diagram depicting an example of the structure of a success support system in Exemplary Embodiment 1.

FIG. 2 It is a block diagram depicting an example of the structure of a proposal unit 12 in more detail.

FIG. 3 It is a flowchart depicting an example of the operation of the success support system in Exemplary Embodiment 1.

FIG. 4 It is a flowchart depicting an example of the operation in a proposal step in more detail.

FIG. 5 It is a block diagram depicting another example of the structure of the success support system 10.

FIG. 6 It is a block diagram depicting another example of the structure of the success support system 10.

FIG. 7 It is a block diagram depicting an example of the structure of a marriage simulation system 100 in Exemplary Embodiment 2.

FIG. 8 It is an explanatory diagram depicting an example of the data structure of desired conditions.

FIG. 9 It is an explanatory diagram depicting an example of the data structure of user information.

FIG. 10 It is an explanatory diagram depicting an example of the data structure of matching results.

FIG. 11 It is an explanatory diagram depicting an example of the data structure of first estimation results (matching rate prediction results).

FIG. 12 It is an explanatory diagram depicting an example of the data structure of marriage results.

FIG. 13 It is an explanatory diagram depicting an example of the data structure of second estimation results (marriage rate prediction results).

FIG. 14 It is an explanatory diagram depicting an example of a simulation result display method.

FIG. 15 It is a flowchart depicting an example of the operation in a matching learning step in the marriage simulation system 100.

FIG. 16 It is a flowchart depicting an example of the operation in a marriage learning step in the marriage simulation system 100.

FIG. 17 It is a flowchart depicting an example of the operation in a matching prediction step in the marriage simulation system 100.

FIG. 18 It is a flowchart depicting an example of the operation in a marriage prediction step in the marriage simulation system 100.

FIG. 19 It is a flowchart depicting an example of the operation in a marriage simulation step in the marriage simulation system 100.

FIG. 20 It is an explanatory diagram depicting another example of the simulation result display method.

FIG. 21 It is an explanatory diagram depicting another example of the simulation result display method.

FIG. 22 It is an explanatory diagram depicting another example of the simulation result display method.

### DESCRIPTION OF THE PREFERRED EMBODIMENTS

### Exemplary Embodiment 1

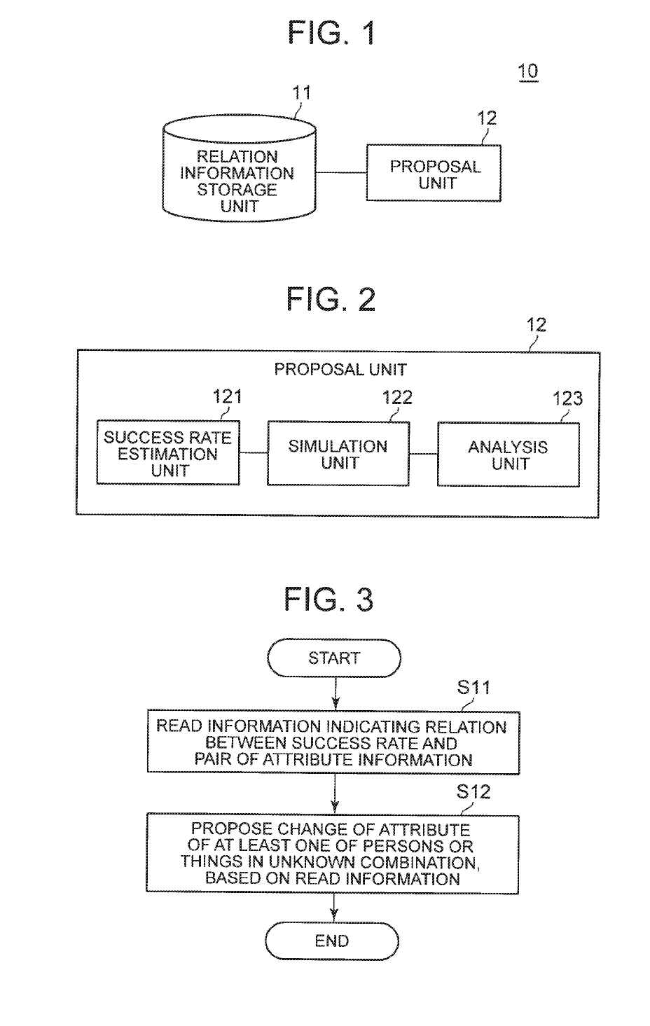

The following describes exemplary embodiments of the present invention with reference to drawings. FIG. 1 is a block diagram depicting an example of the structure of a success support system according to Exemplary Embodiment 1 of the present invention. A success support system 10 depicted in FIG. 1 includes a relation information storage unit 11 and a proposal unit 12.

The relation information storage unit 11 stores information indicating the relation between the success rate for a predetermined purpose of persons or things and the attribute information of each of the persons or things.

For example, the success rate may be the marriage rate. The success rate is not limited to the marriage rate, and may be the success rate for a predetermined purpose, such as dating, in the process leading to marriage. The success rate is also not limited to marriage, and may be the success rate for a coordinated project in business or the like. The object for which the success rate is measured is not limited to persons, and may be animals and plants, microorganisms, chemical substances, etc. In this exemplary embodiment, the success rate generally refers to the possibility of success in a matter the success or failure of which depends on compatibility.

The attribute information is not limited to information specific to the person or thing such as nature, feature, and title, and may include information about any product (such as documents) by the person or thing.

The proposal unit 12 proposes a change of at least a part of the attribute information of at least one of the persons or things in an unknown combination, based on the information stored in the relation information storage unit 11.

For example, the proposal unit 12 may propose such a change, by presenting a change of at least one item included in the attribute information of at least one of the persons or things and the success rate after the change estimated based on the information stored in the relation information storage unit 11.

In the case where the success rate involves users registered in advance, such as the success rate for a predetermined purpose of users registered as members, the proposal unit 12 may propose a change for improving the success rate in the combination of a first user and a second user who meets the condition designated by the first user, the change being a change of at least a part of the attribute information of the first user. As another example of the proposal for the same purpose, the proposal unit 12 may propose a change of at least one item that is included in the attribute information of the second user and matches the condition designated by the first user.

The above-mentioned change may be made only to an item (or items) designated as a changeable item.

FIG. 2 is a block diagram depicting an example of the structure of the proposal unit 12 in more detail. The proposal unit 12 may include a success rate estimation unit 121, a simulation unit 122, and an analysis unit 123, as depicted in FIG. 2.

The success rate estimation unit 121, when a pair of attribute information is input, estimates the success rate for the predetermined purpose by the pair of attribute information, based on the input pair of attribute information and the information stored in the relation information storage unit 11.

The simulation unit 122, upon receiving designation of any combination of persons or things, changes at least a part of the attribute information of at least one of the persons or things in the designated combination, and simulates a change of the success rate associated with the change.

The analysis unit 123 identifies, based on the simulation result, the changed part in the pair of attribute information by the combination of persons or things for improving the success rate for the predetermined purpose by the combination, the contents of the change, or the contribution of the change.

For example, the proposal unit 12 having the structure depicted in FIG. 2 may propose the change by displaying the success rate after the change together with the changed part, the contents of that change, or contribution of the change identified by the analysis unit 123.

FIG. 3 is a flowchart depicting an example of the operation in this exemplary embodiment. In the example depicted in FIG. 3, when any combination whose success rate is unknown is designated, the proposal unit 12 reads the information indicating the relation between the success rate for the predetermined purpose of persons or things and the attribute information of each of the persons or things stored in the relation information storage unit 11 (step S11). Here, the proposal unit 12 may also read the attribute information of each of the persons or things in the designated unknown combination.

Based on the information indicating the relation between the success rate for the predetermined purpose of persons or things and the attribute information of each of the persons or things read from the relation information storage unit 11, the proposal unit 12 proposes a change of at least a part of the attribute information of at least one of the persons or things in the designated unknown combination (step S12). In step S12, the proposal unit 12 may change at least a part of the attribute information of at least one of the persons or things in the designated unknown combination, analyze a change of the success rate associated with the change of the attribute information, and display the changed part for improving the success rate, the contens of the change, or a contribution of the change identified as a result, thus proposing the change.

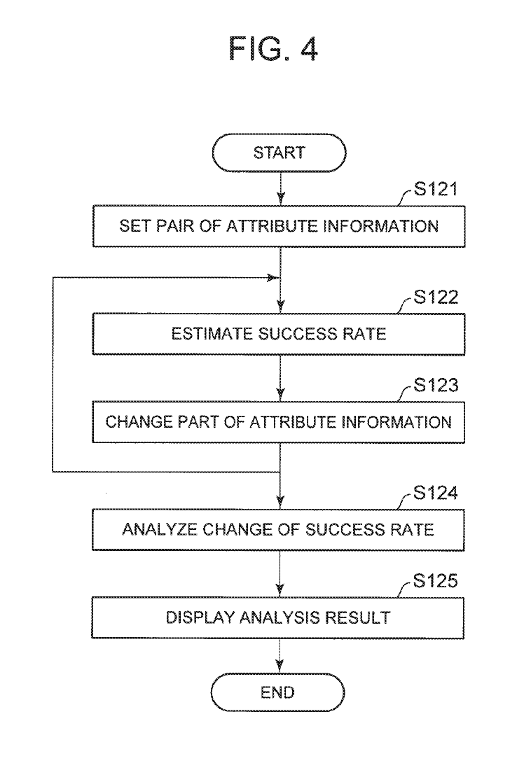

FIG. 4 is a flowchart depicting an example of step S12 of the operation in the proposal step in FIG. 3 in more detail. In the example depicted in FIG. 4, when the unknown combination is designated, the proposal unit 12 (e.g. the simulation unit 122) sets a pair of attribute information made up of the attribute information of the persons or things in the combination (step S121).

Next, the proposal unit 12 (e.g. the simulation unit 122) predicts (estimates) the success rate of the set pair of attribute information, using the success rate estimation unit 121 (step S122). For example, the simulation unit 122 may first have it estimate the success rate of the pair of attribute information made up of the current attribute information of the persons or things in the combination.

Next, the proposal unit 12 (e.g. the simulation unit 122) changes at least a part of the attribute information of at least one of the persons or things, and simulates a change of the success rate associated with the change of the attribute information (step S123 followed by step S122). For example, the simulation unit 122 performs the change a predetermined number of times or for all changeable items, and then advances to step S124.

In step S124, the proposal unit 12 (e.g. the analysis unit 123) analyzes the simulation result, and identifies, for example, the changed part in the pair of attribute information for improving the success rate for the predetermined purpose by the designated combination, the contents of the change, or the contribution of the change.

Lastly, the proposal unit 12 (e.g. the analysis unit 123) displays the analysis result (step S125). In step S125, for example, the analysis unit 123 may display the changed part in the pair of attribute information, the contents of the change, or the contribution of the change that have been identified.

With such a structure, the proposal can be made while taking into account not only the success rate of the combination of the current attribute information but also the success rate of the combination of the attribute information changed in part, based on not human empirical knowledge but objective data of the past results. A more effective matching service can thus be provided.

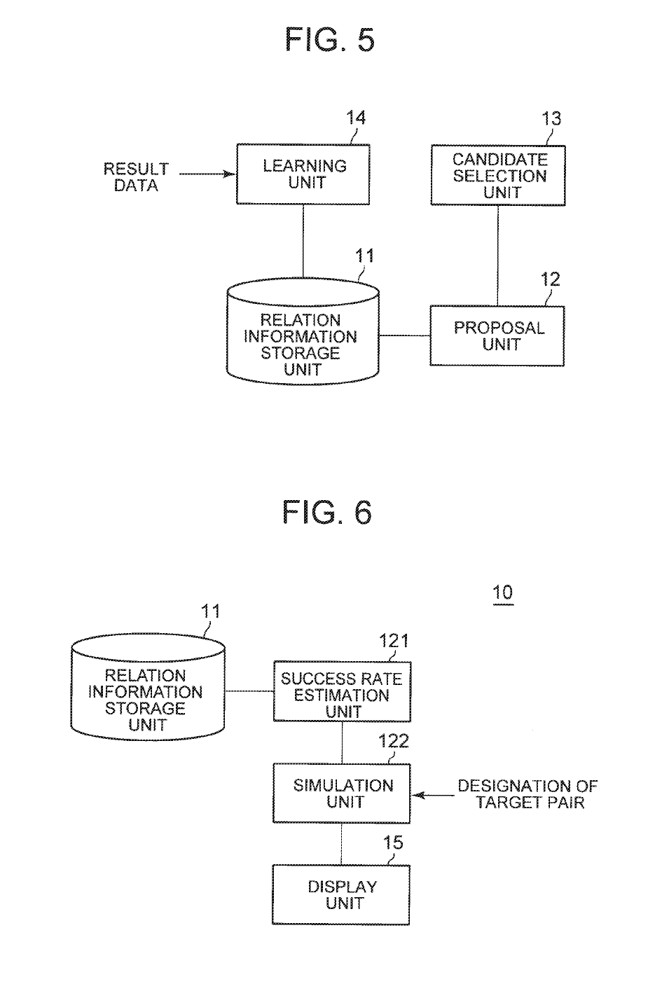

FIG. 5 is a block diagram depicting another example of the structure of the success support system 10. For example, the success support system 10 may further include a candidate selection unit 13 which, based on the desired condition about the attribute information of other persons or things designated by a first person or thing, decreases a number of other persons or things subjected to the simulation of the success rate.

Moreover, for example, the success support system 10 may further include a learning unit 14 which machine-learns the relation between the success rate for the predetermined purpose of any persons or things and the attribute information of each of the persons or things in the combination, using, as learning data, the pair of the attribute information of the persons or things in each combination of persons or things for which the success or failure of the predetermined purpose is determinable. The learning unit 14 enables learning even when the number of dimensions of input data is enormous. The number of dimensions of input data may be 1000 or more, or 10000 or more.

FIG. 6 is a block diagram depicting another example of the structure of the success support system 10. The success support system 10 may include, instead of the analysis unit 123, a display unit 15 which displays the simulation result as depicted in FIG. 6. The display unit 15 may display the changed part in the designated pair of attribute information for improving the success rate for the predetermined purpose by the pair of attribute information, the contents of the change, or the contribution of the change identified based on the simulation result, in the same way as the analysis unit 123.

The above-mentioned candidate selection unit 13 and learning unit 14 may be added to the structure depicted in FIG. 6.

In this exemplary embodiment, the relation information storage unit 11 is realized, for example, by a storage device. The proposal unit 12, the candidate selection unit 13, and the learning unit 14 are realized, for example, by an information processing device operating according to a program. The display unit 15 is realized, for example, by an information processing device operating according to a program and a display device such as a display.

### Exemplary Embodiment 2

The following describes Exemplary Embodiment 2 of the present invention. Although an example where the success rate is the marriage rate is described below, the success rate is not limited to the marriage rate.

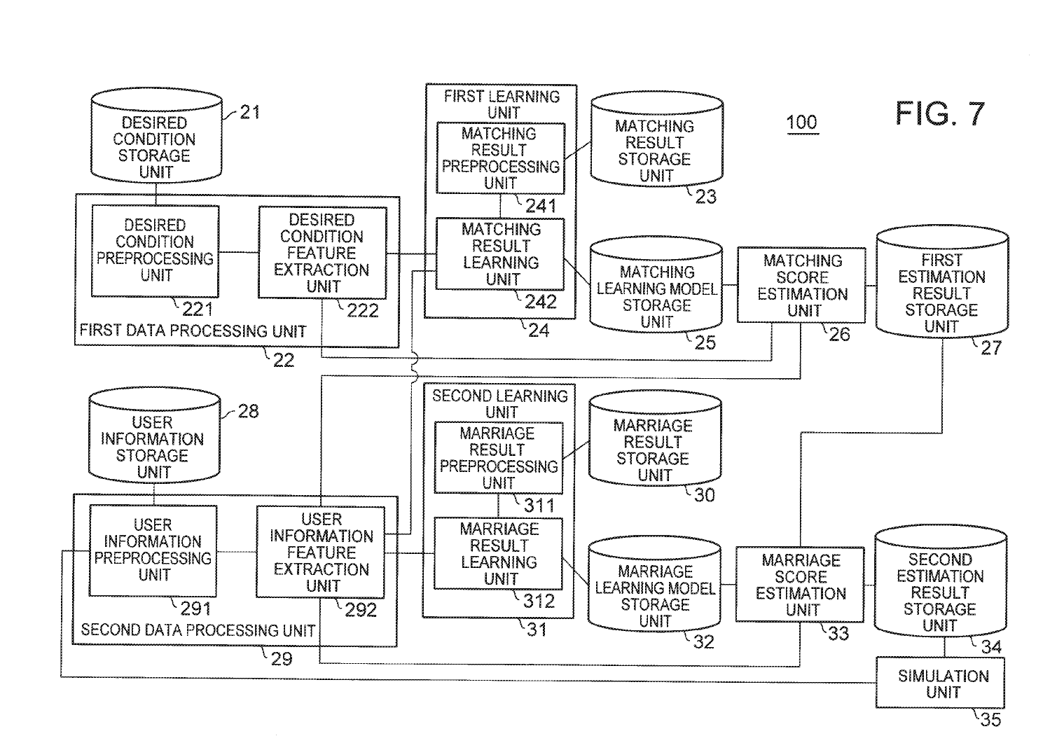

FIG. 7 is a block diagram depicting an example of the structure of a marriage simulation system 100 in this exemplary embodiment. The marriage simulation system 100 is another example of the success support system 10 in Exemplary Embodiment 1. The marriage simulation system 100 depicted in FIG. 7 includes a desired condition storage unit 21, a first data processing unit 22, a matching result storage unit 23, a first learning unit 24, a matching learning model storage unit 25, a matching score estimation unit 26, a first estimation result storage unit 27, a user information storage unit 28, a second data processing unit 29, a marriage result storage unit 30, a second learning unit 31, a marriage learning model storage unit 32, a marriage score estimation unit 33, a second estimation result storage unit 34, and a simulation unit 35.

The first data processing unit 22 includes a desired condition preprocessing unit 221 and a desired condition feature extraction unit 222. The first learning unit 24 includes a matching result preprocessing unit 241 and a matching result learning unit 242. The second data processing unit 29 includes a user information preprocessing unit 291 and a user information feature extraction unit 292. The second learning unit 31 includes a marriage result preprocessing unit 311 and a marriage result learning unit 312.

The marriage simulation system 100 is realized, for example, by an information processing device such as a server device or an information processing terminal an example of which is a personal computer, and a storage device group such as a database system accessible by the information processing device. The first data processing unit 22, the first learning unit 24, the matching score estimation unit 26, the second data processing unit 29, the second learning unit 31, the marriage score estimation unit 33, and the simulation unit 35 may be realized, for example, by a CPU included in the information processing device. In this case, the CPU reads a program describing the operation of each processing unit stored in a predetermined storage device and operates according to the program, to realize the function of each processing unit. The desired condition storage unit 21, the matching result storage unit 23, the matching learning model storage unit 25, the first estimation result storage unit 27, the user information storage unit 28, the marriage result storage unit 30, the marriage learning model storage unit 32, and the second estimation result storage unit 34 may be realized, for example, by the storage device group accessible by the information processing device. The number of storage devices may be one or more.

The desired condition storage unit 21 holds desired conditions which are conditions desired of partners by matching service users (hereafter simply referred to as “users”). Examples of the desired conditions include age, height, weight, character, etc. held as part of the attribute information of each user.

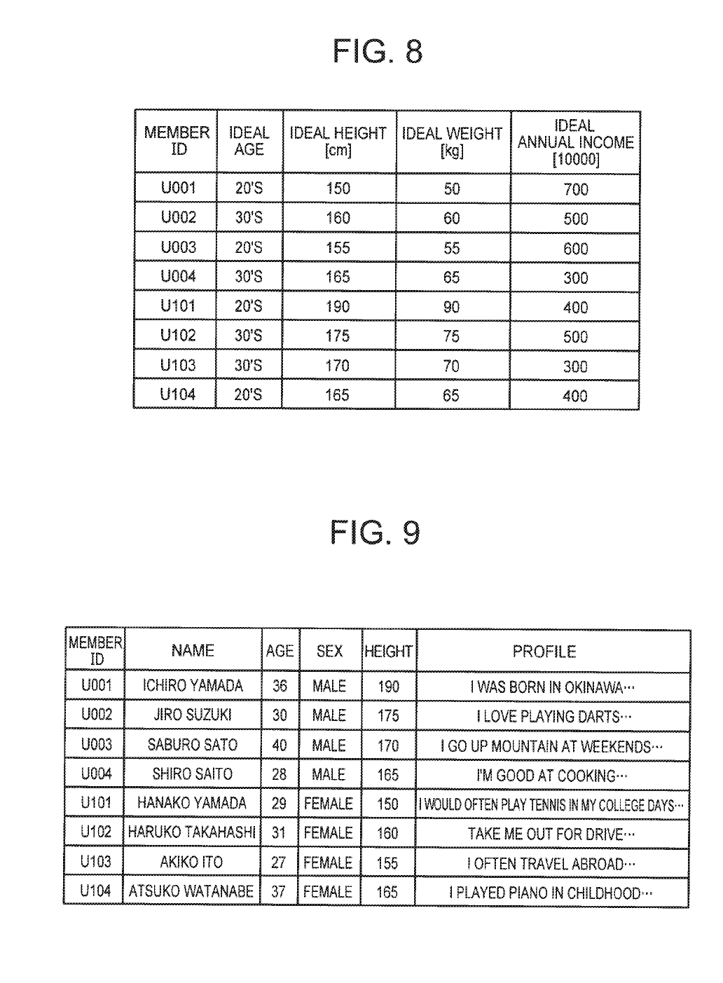

FIG. 8 is an explanatory diagram depicting an example of the data structure of the desired conditions held in the desired condition storage unit 21. For example, the desired condition storage unit 21 may hold, in association with a member ID as the identification information of each user, information designating the contents of at least one item of attribute information such as age, height, weight, and annual income desired of a partner, as depicted in FIG. 8.

The user information storage unit 28 holds user information which is the attribute information of each user. Examples of the user information include personal information such as name, age, sex, and education. The user information may include information generated by the user through a social networking service (SNS) or the like.

FIG. 9 is an explanatory diagram depicting an example of the data structure of the user information held in the user information storage unit 28. For example, the user information storage unit 28 may hold, in association with a member ID as the identification information of each user, the user's name, age, sex, height, textual profile data, etc. as user information, as depicted in FIG. 9. The user information may include information about the desired condition of the user.

The first data processing unit 22 processes a designated desired condition into a data form that can be handled by the first learning unit 24.

In this exemplary embodiment, the desired condition preprocessing unit 221 may, for example, read a record including the designated desired condition of the user from the desired condition storage unit 21 and generate a desired condition vector, according to an instruction from the desired condition feature extraction unit 222. The desired condition vector represents the desired condition by a multidimensional numerical vector.

The desired condition feature extraction unit 222, for example, performs feature extraction on the desired condition vector generated by the desired condition preprocessing unit 221, and generates a desired condition feature vector. The desired condition feature vector may be any numerical vector with a smaller number of dimensions than the desired condition vector.

The second data processing unit 29 processes designated user information into a data form that can be handled by the second learning unit 31.

In this exemplary embodiment, the user information preprocessing unit 291 may, for example, read a record including the designated user information from the user information storage unit 28 and generate a user vector, according to an instruction from the user information feature extraction unit 292. The user vector represents the user information by a multidimensional numerical vector.

The user information feature extraction unit 292 performs feature extraction on the user vector generated by the user information preprocessing unit 291, and generates a user feature vector. The user feature vector may be any numerical vector with a smaller number of dimensions than the user vector.

The matching result storage unit 23 holds matching results. An example of information indicating a matching result is information associating the desired condition of a user and the user information of another user matching the desired condition of the user with each other. Another example of the information indicating the matching result is information associating the desired condition of a user and the user information of another user not matching the desired condition of the user with each other. Another example of the information indicating the matching result is information associating the desired condition of a user, the user information of another user, and information indicating whether or not the user information matches the desired condition with each other.

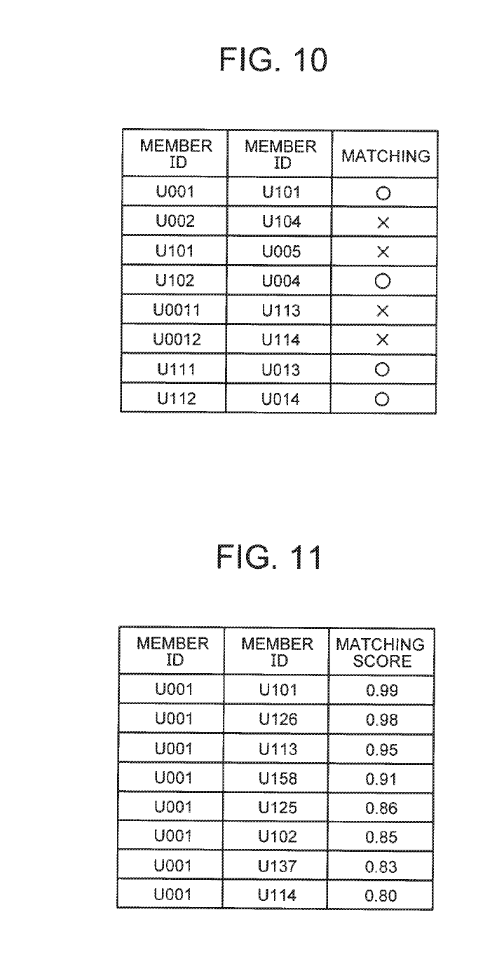

FIG. 10 is an explanatory diagram depicting an example of the data structure of the matching results held in the matching result storage unit 23. For example, the matching result storage unit 23 may hold, for each pair subjected to matching determination in the past, information associating the member ID (desired condition identifying information) of a user designating a desired condition, the member ID (target person identifying information) of another user as a matching candidate of the user, and information indicating the result of matching determination with each other as a matching result, as depicted in FIG. 10.

The first learning unit 24 learns the relation of matching potential between the desired condition of a user and the user information of another user (in more detail, a matching score indicating the degree to which the user information matches the desired condition), based on the information indicating the matching result stored in the matching result storage unit 23.

In this exemplary embodiment, the first learning unit 24 generates, for any combination of a desired condition and user information, a matching learning model indicating the relation of matching score by machine learning, using information that includes a desired condition feature vector, a user feature vector, and a label indicating whether or not the two feature vectors match and is generated based on the information indicating the matching result stored in the matching result storage unit 23. The first learning unit 24 may generate a matching learning model indicating the relation of matching score for not only a combination of the desired condition of a user and the user information of another user matching the desired condition but also a combination of the desired conditions and user information of both users. For example, the first learning unit 24 may generate a matching learning model indicating the relation of matching score for a combination of each of user information including desired conditions.

In more detail, the matching result preprocessing unit 241 reads the information indicating the matching result from the matching result storage unit 23, and generates label information <member ID (desired condition identifying information), member ID (target person identifying information), success/failure label indicating whether or not the two values match> as an example, according to an instruction from the matching result learning unit 242.

The matching result learning unit 242 generates, based on the label information generated by the matching result preprocessing unit 241, learning data <desired condition feature vector, user feature vector, success/failure label> using the desired condition feature vector of the member ID (desired condition identifying information) generated by the desired condition feature extraction unit 222 and the user feature vector of the member ID (target person identifying information) generated by the user information feature extraction unit 292, and generates a matching learning model by machine learning.

The matching learning model storage unit 25 holds the learning result by the first learning unit 24 (in more detail, the matching result learning unit 242), that is, information indicating the matching learning model. The information indicating the matching learning model may be, for example, information indicating the relation between the combination of the desired condition feature vector and the user feature vector and the matching score.

The matching score estimation unit 26 reads the learning result by the first learning unit 24 (the information indicating the matching learning model) stored in the matching learning model storage unit 25, and estimates (calculates) the matching score for an unknown combination of a desired condition and user information indicated by an unknown pair of member IDs. The matching score estimation unit 26 may calculate the matching score for a combination of desired conditions and user information of the users selected as candidates. For example, the matching score estimation unit 26 may calculate the matching score, using a learning model obtained by learning the relation of matching score for the combination of desired conditions and user information of the users selected as candidates. Alternatively, the matching score estimation unit 26 may calculate a first matching score for the combination of the desired condition of the designated user and the user information of another user, calculate a second matching score for the combination of the desired condition of the other user and the user information of the designated user, and set a sum of the first and second matching scores as the eventual matching score.

The first estimation result storage unit 27 holds the matching score calculated by the matching score estimation unit 26 as a first estimation result, together with the pair of member IDs subjected to the calculation.

FIG. 11 is an explanatory diagram depicting an example of the data structure of the first estimation results (matching rate prediction results) held in the first estimation result storage unit 27. For example, the first estimation result storage unit 27 may hold, for each user combination subjected to the matching score calculation, information associating the member ID identifying the user designating the desired condition, the member ID identifying the user subjected to the matching score calculation with regard to the desired condition, and the matching score, as depicted in FIG. 11.

The marriage result storage unit 30 holds marriage results. An example of information indicating a marriage result is information associating, for a combination of members who ended up getting married in the past, the member ID of one member and the member ID of the other member with each other. Another example of the information indicating the marriage result is information associating, for a combination of members who ended up not getting married in the past, the member ID of one member and the member ID of the other member with each other. Another example of the information indicating the marriage result is information associating, for a combination of members who were introduced to each other in the past, the member ID of one member, the member ID of the other member, and information indicating whether or not they ended up getting married with each other. The information indicating the marriage result is not limited to these information, and may include information such as the date and time of introduction, the date and time of marriage in the case where the members ended up getting married, and the date and time of decision not to marry in the case where the members ended up not getting married.

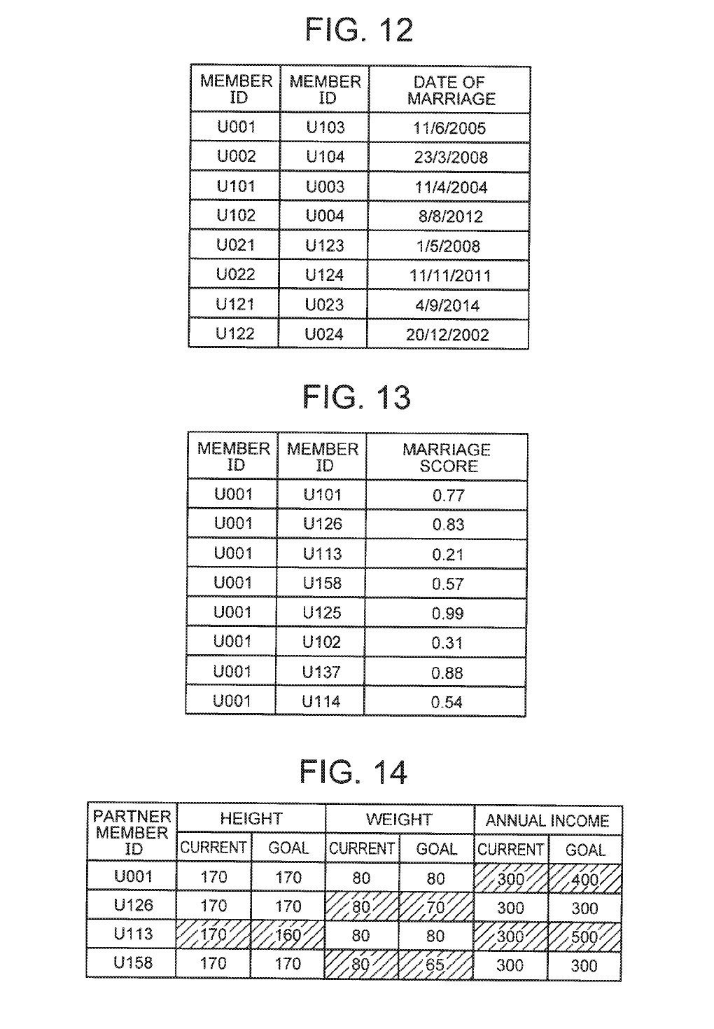

FIG. 12 is an explanatory diagram depicting an example of the data structure of the marriage results held in the marriage result storage unit 30. The marriage result storage unit 30 may hold, for each combination of members who ended up getting married, information including the member IDs of both members and the date and time of marriage, as depicted in FIG. 12.

The second learning unit 31 learns the relation of marriage potential between a user and another user (in more detail, a marriage score indicating the possibility to end up getting married), based on the information indicating the marriage result stored in the marriage result storage unit 30.

In this exemplary embodiment, the second learning unit 31 generates, for any combination of user information, a marriage learning model indicating the relation of marriage score by machine learning, using information that includes a first user feature vector, a second user vector, and a success/failure label indicating whether or not they ended up getting married and is generated based on the information indicating the marriage result stored in the marriage result storage unit 30.

In more detail, the marriage result preprocessing unit 311 reads the information indicating the marriage result from the marriage result storage unit 30, and generates label information <member ID (first target person identifying information), member ID (second target person identifying information), success/failure label indicating whether or not the two ended up getting married>, according to an instruction from the marriage result learning unit 312.

The marriage result learning unit 312 generates, based on the label information generated by the marriage result preprocessing unit 311, learning data <user feature vector of first target person, user feature vector of second target person, success/failure label> using the user feature vector of one user (the user feature vector of the first target person) and the user feature vector of the other user (the user feature vector of the second target person) corresponding to the past marriage result, and generates a marriage learning model by machine learning. Here, the marriage result learning unit 312 may learn the weight of each item of user information on the marriage score, and include the learning result in the marriage learning model.

The marriage learning model storage unit 32 holds the learning result by the marriage result learning unit 312, that is, information indicating the marriage learning model. The information indicating the marriage learning model may be, for example, information indicating the relation between the pair of user feature vectors and the marriage score.

The marriage score estimation unit 33 reads the learning result by the second learning unit 31 (the information indicating the marriage learning model) stored in the marriage learning model storage unit 32, and estimates (calculates) the marriage score for an unknown combination of user information of two users indicated by the designated pair of member IDs.

In this exemplary embodiment, the marriage score estimation unit 33 reads the first estimation results from the first estimation result storage unit 27, and sets, as a candidate subjected to the marriage score estimation, another user (fourth target person) matching the desired condition of the designated user (third target person) or matching the desired condition to a high degree. In more detail, the marriage score estimation unit 33 sets another user (fourth target person) whose matching score for the desired condition of the designated user (third target person) is a predetermined value or more or is high in order, as a candidate. The marriage score estimation unit 33 then generates the user feature vector of the third target person and the user feature vector of the fourth target person. The marriage score estimation unit 33 estimates (calculates) the marriage score for the pair of the user feature vector of the third target person and the user feature vector of one of the fourth target persons, using the marriage learning model.

The second estimation result storage unit 34 holds the marriage score calculated by the marriage score estimation unit 33 as a second estimation result, together with the pair of member IDs subjected to the calculation.

FIG. 13 is an explanatory diagram depicting an example of the data structure of the second estimation results (marriage rate prediction results) held in the second estimation result storage unit 34. For example, the second estimation result storage unit 34 may hold, for each user combination subjected to the marriage score calculation, information associating the member ID identifying the third target person, the member ID identifying the fourth target person, and the marriage score with each other, as depicted in FIG. 13.

The simulation unit 35 reads the second estimation results from the second estimation result storage unit 34, and simulates the possibility of a user marrying another user whose matching score is high in order.

For example, the simulation unit 35 may display the marriage score of the combination of the current user information of a user (third target person) and the current user information of another user (fourth target person) whose matching score for the user is high in order, as the prediction result of the current marriage rate with the partner. Based on this prediction result, the simulation unit 35 changes the user information of at least one user in each combination, and analyzes how the marriage score changes with the change of the user information. Here, the simulation unit 35 may search for such user information of the third target person that maximizes the marriage score with a predetermined partner or maximizes the total marriage score with a partner whose matching score is high in order, and output the difference between the result and the current user information.

The simulation unit 35 may present the changed part in the user information and the change, as goal setting for the user as the third target person. Moreover, for example, the simulation unit 35 may search for such a combination of user information that maximizes the total marriage score with a partner who meets part of the desired condition regardless of the matching score, and output the difference between the result and the current combination of user information. Here, the simulation unit 35 may present the changed part in the user information of the fourth target person and the change, as a change proposal for the desired condition of the user as the third target person.

FIG. 14 is an explanatory diagram depicting an example of the simulation result display method. FIG. 14 depicts an example of displaying user information differences, as an example of information displayed as a result of simulation. The simulation unit 35 may present, as a change proposal for the user (third target person) designating the desired condition, a goal setting value (changed value) for at least one item identified as a result of simulation together with the current user information of the user (third target person) in association with the member ID of the partner user (fourth target person) subjected to the simulation, as depicted in FIG. 14. The simulation unit 35 may present the weight of the item (the degree of influence on the marriage score) together with the goal setting value. For example, the weight may be extracted by machine learning performed by the marriage result learning unit 312 using the past results, or assigned based on the simulation result.

The matching result storage unit 23, the first learning unit 24, the matching learning model storage unit 25, the matching score estimation unit 26, and the first estimation result storage unit 27 in this exemplary embodiment correspond to the candidate selection unit 13 in Exemplary Embodiment 1. The marriage learning model storage unit 32 corresponds to the relation information storage unit 11 in Exemplary Embodiment 1. The second learning unit 31 corresponds to the learning unit 14 in Exemplary Embodiment 1. The marriage score estimation unit 33 and the simulation unit 35 correspond to the proposal unit 12 in Exemplary Embodiment 1.

The following describes the operation in this exemplary embodiment. The operation of the marriage simulation system 100 in this exemplary embodiment includes five steps, namely, a matching learning step, a marriage learning step, a matching prediction step, a marriage prediction step, and a marriage simulation step.

The matching learning step mainly machine-learns the relation of matching score for each combination of a desired condition and user information based on the past matching results, and generates a matching learning model as the learning result.

The marriage learning step mainly machine-learns the relation of marriage score for each combination of user information based on the past marriage results, and generates a marriage learning model as the learning result.

The matching prediction step reads the learning result in the matching learning step, and calculates the matching score of members using the designated combination of a desired condition and user information.

The marriage prediction step reads the matching score calculation result in the matching prediction step and the learning result in the marriage learning step, and calculates the marriage score of the current user information of the members using the combination of the user information of the designated user and the user information of another user whose matching score for the user is high in order.

The marriage simulation step reads the marriage score of the current user information of the members calculated in the marriage prediction step, searches for such a combination of user information that increases the marriage score by simulation, and proposes a change for increasing the marriage rate to the designated user based on the user information difference obtained as a result of the search.

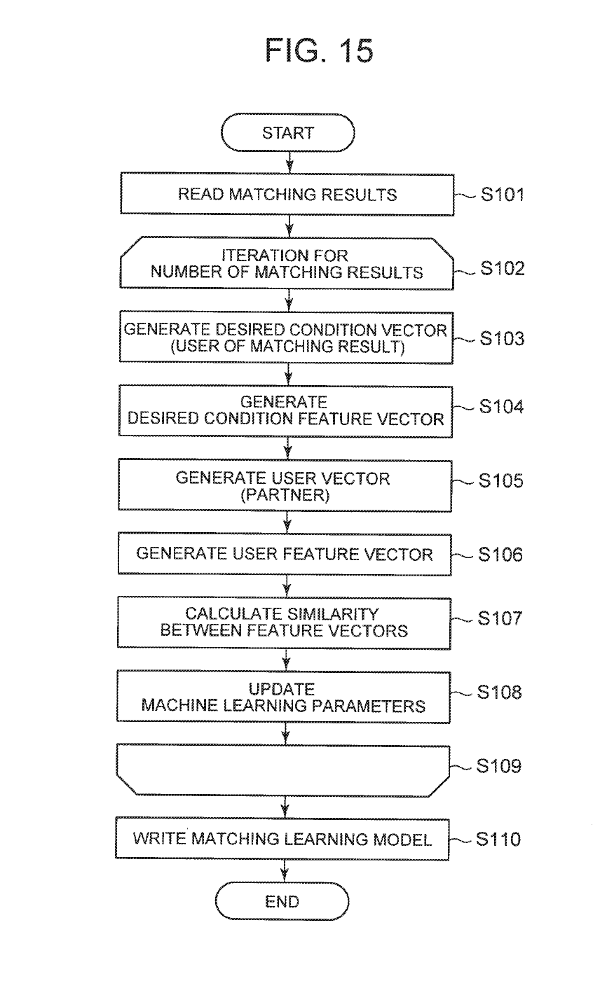

FIG. 15 is a flowchart depicting an example of the operation in the matching learning step in the marriage simulation system 100. In the example depicted in FIG. 15, first the matching result preprocessing unit 241 reads, from the matching result storage unit 23, each matching result which is the history of matching of the desired condition and user information of members in the past, and generates label information <member ID (desired condition identifying information), member ID (target person identifying information), success/failure label> (step S101).

Next, the first data processing unit 22, the second data processing unit 29, and the matching result learning unit 242 in the first learning unit 24 perform the operations in steps S103 to S108 for the number of matching results (steps S102, S109).

In step S103, the desired condition preprocessing unit 221 reads the desired condition of the user indicated by the label information generated in step S101 from the desired condition storage unit 21, and generates a desired condition vector. Here, at least the desired condition of the user indicated by the member ID as the desired condition identifying information is read. In the case of taking into account the desired conditions of both members, the desired condition of the user indicated by the member ID as the target person identifying information may be read, too. For example, the desired condition preprocessing unit 221 reads a record matching the member ID as the desired condition identifying information from the desired condition storage unit 21, and converts the record into a vector form to generate a desired condition vector.

The desired condition is vectorized (quantified) in the following method as an example. The desired condition preprocessing unit 221 first divides each textual item such as a profile into words using morphological analysis, and vectorizes the presence or absence of each word using a predetermined value (e.g. 0 or 1). Regarding each non-textual item (such as height, weight, and education), the desired condition preprocessing unit 221 does not divide the item into words, and vectorizes whether or not the item is included in a predetermined range classified beforehand using a predetermined value in the same way as above.

In step S104, the desired condition feature extraction unit 222 reads the desired condition vector generated in step S103, performs feature extraction on the read desired condition vector, and generates a desired condition feature vector.

In step S105, the user information preprocessing unit 291 reads the user information of the user indicated by the label information generated in step S101 from the user information storage unit 28, and generates a user vector. Here, at least the user information of the user indicated by the member ID as the target person identifying information is read. In the case of taking into account the desired conditions of both members, the user information of the user indicated by the member ID as the desired condition identifying information may be read, too. For example, the user information preprocessing unit 291 reads a record matching the member ID from the user information storage unit 28, and converts the record into a vector form to generate a user vector. The user information may be vectorized (quantified) by the same method as the desired condition vector generation method in step S103.

In step S106, the user information feature extraction unit 292 reads the user vector generated in step S105, performs feature extraction on the read user vector, and generates a user feature vector.

In steps S107 and S108, the matching result learning unit 242 adjusts the model parameters of the matching learning model, using the desired condition feature vector generated in step S104, the user feature vector generated in step S106, and the success/failure label acquired in step S101.

In this exemplary embodiment, the matching result learning unit 242 first calculates the cosine similarity between the desired condition feature vector and the user feature vector (step S107). The matching result learning unit 242 then updates the model parameters using the calculated cosine similarity and the success/failure label. The learning method is, however, not limited to this.

Having performed the above-mentioned process for the number of matching results, the matching result learning unit 242 writes the eventually adjusted model parameters to the matching learning model storage unit 25 (step S110), and ends the matching learning step.

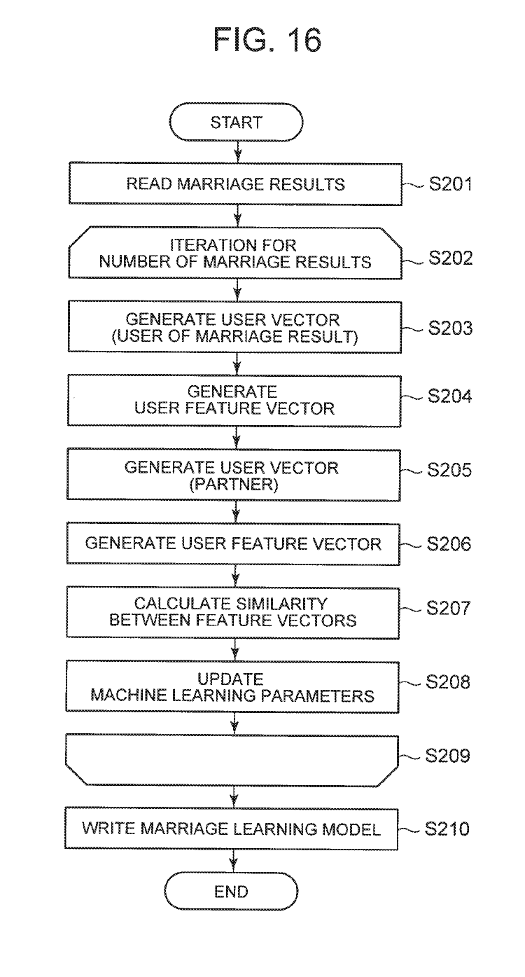

FIG. 16 is a flowchart depicting an example of the operation in the marriage learning step in the marriage simulation system 100.

In the example depicted in FIG. 16, first the marriage result preprocessing unit 311 reads, from the marriage result storage unit 30, each marriage result which is the history of marriage of members in the past, and generates label information <member ID (first target person identifying information), member ID (second target person identifying information), success/failure label> (step S201).

Next, the second data processing unit 29 and the marriage result learning unit 312 in the second learning unit 31 perform the operations in steps S203 to S208 for the number of marriage results (steps S202, S209).

In step S203, the user information preprocessing unit 291 reads the user information of the first target person indicated by the label information generated in step S201 from the user information storage unit 28, and generates a user vector. For example, the user information preprocessing unit 291 reads a record matching the member ID as the first target person identifying information from the user information storage unit 28, and converts the record into a vector form to generate a user vector. The user information may be vectorized (quantified) by the same method as the user vector generation method in step S105.

In step S204, the user information feature extraction unit 292 reads the user vector generated in step S203, performs feature extraction on the read user vector, and generates a user feature vector.

In step S205, the user information preprocessing unit 291 reads the user information of the second target person indicated by the label information generated in step S201 from the user information storage unit 28, and generates a user vector. For example, the user information preprocessing unit 291 reads a record matching the member ID as the second target person identifying information from the user information storage unit 28, and converts the record into a vector form to generate a user vector.

In step S206, the user information feature extraction unit 292 reads the user vector generated in step S205, performs feature extraction on the read user vector, and generates a user feature vector.

In steps S207 and S208, the marriage result learning unit 312 adjusts the model parameters of the marriage learning model, using the user feature vector generated in step S204, the user feature vector generated in step S206, and the success/failure label acquired in step S201.

In this exemplary embodiment, the marriage result learning unit 312 first calculates the cosine similarity between the two user feature vectors (step S207). The marriage result learning unit 312 then updates the model parameters using the calculated cosine similarity and the success/failure label. The learning method is, however, not limited to this.

Having performed the above-mentioned process for the number of marriage results, the marriage result learning unit 312 writes the eventually adjusted model parameters to the marriage learning model storage unit 32 (step S210), and ends the marriage learning step.

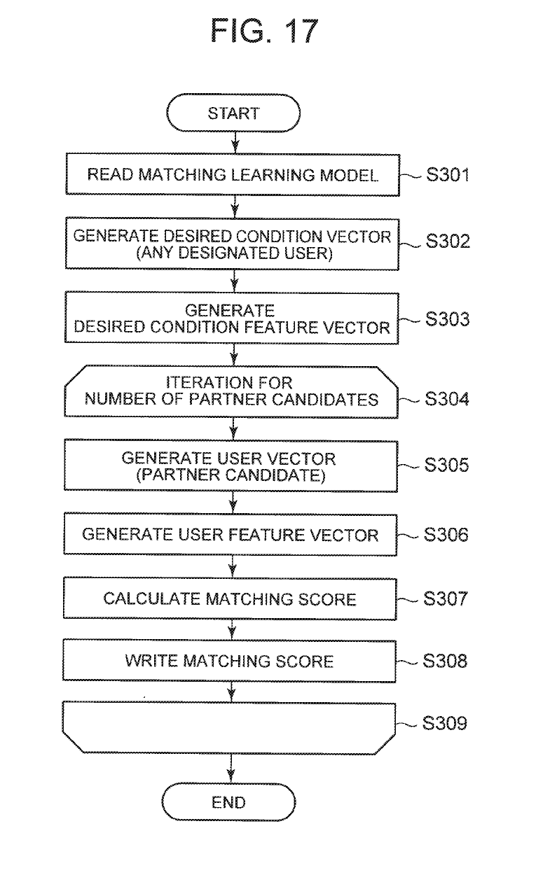

FIG. 17 is a flowchart depicting an example of the operation in the matching prediction step in the marriage simulation system 100.

In the example depicted in FIG. 17, first the matching score estimation unit 26 reads the adjusted model parameters written in step S110 from the matching learning model storage unit 25 (step S301).

The matching score estimation unit 26 then requests the first data processing unit 22 to generate a desired condition feature vector from the desired condition of a user (third target person) subjected to the marriage-related simulation (advance to step S302). For example, the third target person is designated by an advisor or user who uses the system.

In step S302, the desired condition preprocessing unit 221 reads the desired condition of the designated third target person from the desired condition storage unit 21, and generates a desired condition vector.

Next, in step S303, the desired condition feature extraction unit 222 performs feature extraction on the desired condition vector generated in step S302, and generates a desired condition feature vector.

Next, the second data processing unit 29 and the matching score estimation unit 26 perform the operations in steps S305 to S308 for the number of users who are the partner candidates of the third target person (steps S304, S309). The users who are the partner candidates of the third target person may be, for example, all users of the opposite sex currently registered as members. For example, when the third target person is designated, the matching score estimation unit 26 may generate a list of member IDs of users who are the partner candidates of the third target person.

In step S305, the user information preprocessing unit 291 extracts the member IDs included in the list one by one, reads the user information of the user indicated by the extracted member ID from the user information storage unit 28, and generates a user vector.

In step S306, the user information feature extraction unit 292 reads the user vector generated in step S305, performs feature extraction on the read user vector, and generates a user feature vector.

In step S307, the matching score estimation unit 26 calculates the matching score of the third target person and the user as the partner candidate, using the model parameters read in step S301, the desired condition feature vector generated in step S303, and the user feature vector generated in step S306.

In step S308, the matching score estimation unit 26 writes the calculation result in step S307 to the first estimation result storage unit 27. For example, the matching score estimation unit 26 may write the calculation result in the form <member ID (desired condition identifying information), member ID (target person identifying information), matching score> to the first estimation result storage unit 27.

Having performed the above-mentioned process for the number of partner candidates, the matching score estimation unit 26 ends the matching prediction step.

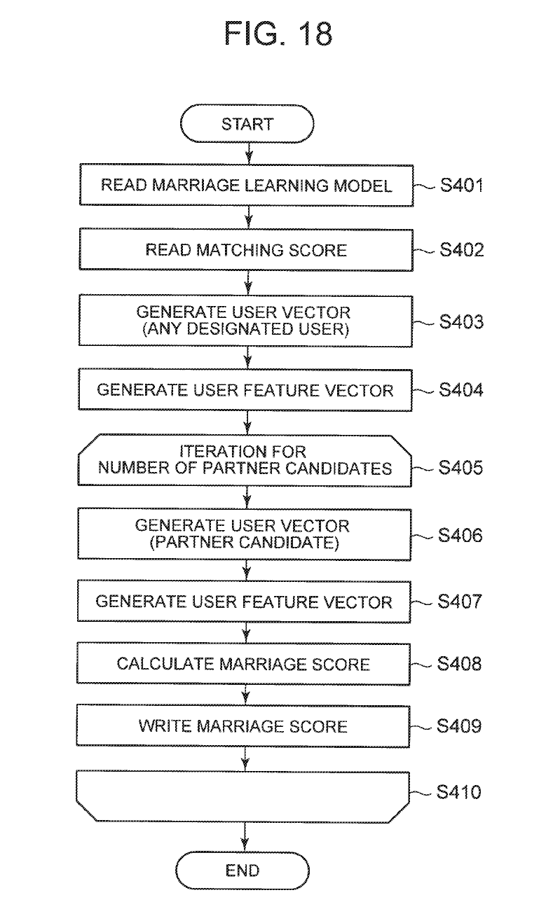

FIG. 18 is a flowchart depicting an example of the operation in the marriage prediction step in the marriage simulation system 100.

In the example depicted in FIG. 18, first the marriage score estimation unit 33 reads the adjusted model parameters written in step S210 from the marriage learning model storage unit 32 (step S401).

The marriage score estimation unit 33 then reads, from the first estimation result storage unit 27, the higher N records from among the estimation results (first estimation results) of matching score with the designated third target person (step S402).

The marriage score estimation unit 33 requests the second data processing unit 29 to generate a user feature vector of the third target person (advance to step S403).

In step S403, the user information preprocessing unit 291 reads the user information of the designated third target person from the user information storage unit 28, and generates a user vector.

Next, in step S404, the user information feature extraction unit 292 performs feature extraction on the user vector generated in step S403, and generates a user feature vector.

Next, the second data processing unit 29 and the marriage score estimation unit 33 perform the operations in steps S406 to S409 for the number of partner candidates (fourth target persons) subjected to the estimation of marriage score with the third target person (steps S405, S410). The fourth target persons may be, for example, the users who are the partner candidates of the third target person, that is, the users indicated by the member IDs as the user identifying information, in the higher N records of matching score read in step S402. For example, when the third target person is designated, the marriage score estimation unit 33 may generate a list of member IDs of users who are the fourth target persons. The number of members presented to the user as candidates can be adjusted by adjusting the number N.

In the iteration process, first the marriage score estimation unit 33 designates the users in the fourth target person list one by one, and requests the second data processing unit 29 to generate a user feature vector (advance to step S406).

In step S406, the user information preprocessing unit 291 reads the user information of the designated fourth target person from the user information storage unit 28, and generates a user vector.

In step S407, the user information feature extraction unit 292 performs feature extraction on the user vector generated in step S406, and generates a user feature vector.

In step S408, the marriage score estimation unit 33 calculates the marriage score of the third target person and the designated fourth target person, using the model parameters read in step S401 and the user feature vectors generated in steps S404 and S407.

In step S409, the marriage score estimation unit 33 writes the calculation result in step S408 to the second estimation result storage unit 34. For example, the marriage score estimation unit 33 may write the calculation result in the form <member ID (third target person identifying information), member ID (fourth target person identifying information), marriage score> to the second estimation result storage unit 34.

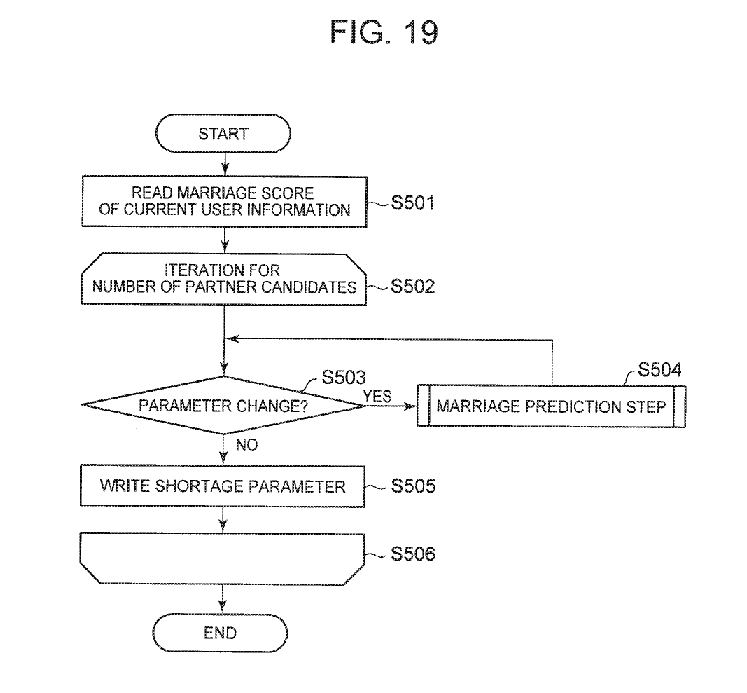

FIG. 19 is a flowchart depicting an example of the operation in the marriage simulation step in the marriage simulation system 100.

In the example depicted in FIG. 19, first the simulation unit 35 reads each marriage score written in step S409 from the second estimation result storage unit 34 (step S501).

Next, the simulation unit 35, the second data processing unit 29, and the marriage score estimation unit 33 perform the operations in steps S503 to S505 for the number of partner candidates (fourth target persons) subjected to the estimation of score with the third target person (steps S502, S506). The number of times the operations are performed here may be the number of marriage scores read from the second estimation result storage unit 34 in step S501.

In step S503, the simulation unit 35 extracts one marriage score read in step S501, and performs user information changes in a round-robin method for the combination of users for which the marriage score has been calculated. For example, the simulation unit 35 may acquire the user feature vector of each of the users for which the marriage score has been calculated, and change the elements included in the pair of user feature vectors in sequence. Here, the number of elements subjected to one change is not limited to one. Moreover, the elements to be changed may be limited to changeable elements. Having completed all changes, the simulation unit 35 advances to step S505.

After changing the user information, the simulation unit 35 requests the marriage score estimation unit 33 to perform the above-mentioned marriage prediction step using the changed user information (step S504). The marriage score estimation unit 33 calculates the marriage score using the designated user information, according to the request from the simulation unit 35. Here, the marriage score estimation unit 33 does not perform step S409 of the operation in the marriage prediction step, and outputs the calculated marriage score to the requester. Having received the marriage score of the changed user information, the simulation unit 35 compares the received score with the previous score, and holds the user information corresponding to the maximum score.

Having completed all changes (step S503: No), the simulation unit 35 compares the user information corresponding to the maximum marriage score with the user information before the change, and stores the difference as a shortage parameter (step S505).

Having completed the above-mentioned process for all partner candidates, the simulation unit 35 ends the marriage simulation step.

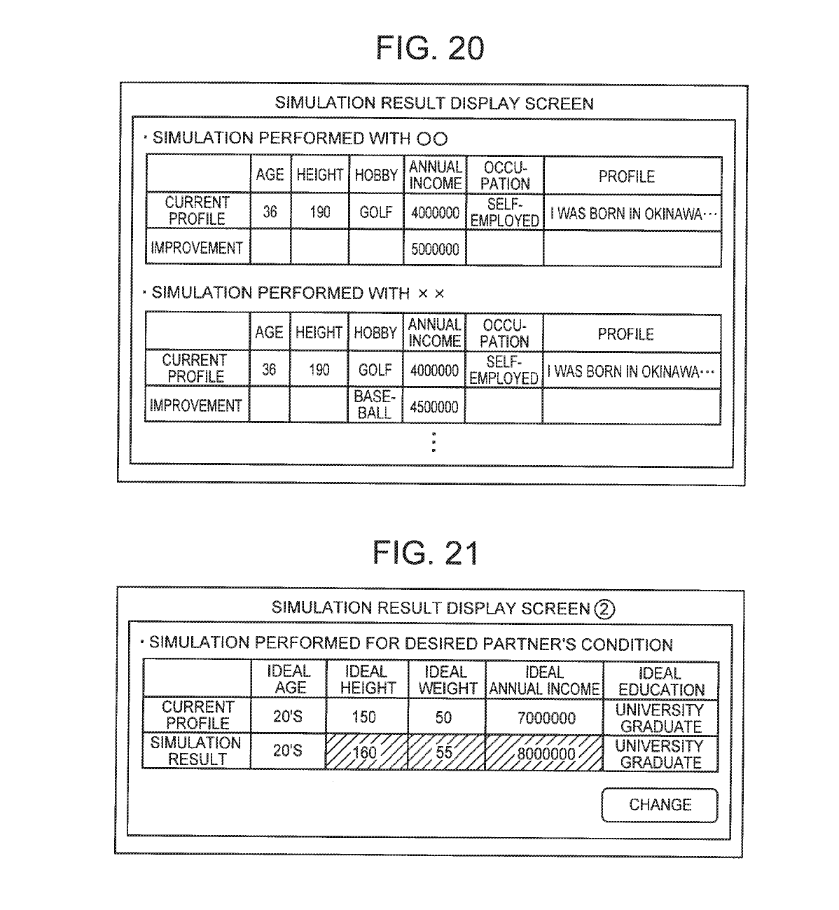

FIG. 20 is an explanatory diagram depicting another example of the simulation result display method. In the case where the marriage score is improved by changing the user information of the user (third target person) designating the desired condition as a result of the simulation, the system may display the changed part and the contents of the change as depicted in FIG. 20, to encourage the third target person to change his or her parameter. In other words, the simulation unit 35 may present, to the user, such a profile that indicates a higher marriage rate with a desired partner in the case of changing the user's profile so that the user can change his or her profile to suit another user. In the example depicted in FIG. 20, an improved profile indicating a higher marriage score as a result of simulation with another member of the opposite sex who satisfies the desired condition is presented to the member, together with the current profile. The information of the partner profile matching the changed desired condition or the marriage score with the partner may be displayed together with the changed desired condition.

FIG. 21 is an explanatory diagram depicting another example of the simulation result display method. In the case where the marriage score is improved by changing the user information of the user (fourth target person) as a partner of the third target person as a result of the simulation, the system may display the changed part and the contents of the change as depicted in FIG. 21, to encourage the third target person to change his or her desired condition. In other words, the simulation unit 35 may present, to the user, such a partner profile that indicates a higher marriage rate in the case of changing the user's desired condition while fixing the user's profile so that the user can increase the marriage rate while maintaining the current profile. In the example depicted in FIG. 21, a desired condition indicating a higher marriage score as a result of simulation for the changed desired condition is presented to the member. The member is thus encouraged to change the desired condition in order to improve the marriage rate. The information of the partner profile matching the changed desired condition or the marriage score with the partner may be displayed together with the changed desired condition.

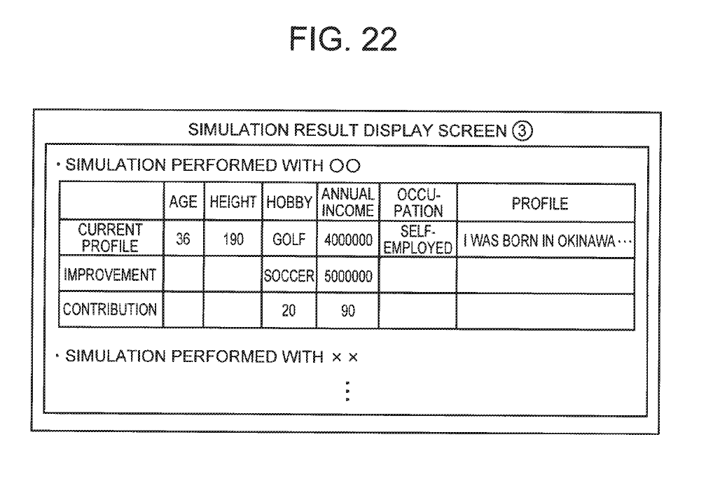

FIG. 22 is an explanatory diagram depicting another example of the simulation result display method. While FIGS. 20 and 21 each depict an example of presenting the changed part and the contents of the change in the current profile or desired condition, the contribution of the change with the item as the changed part may be presented, too. For example, the contribution may be represented by a model parameter, or may be assigned by a method of assigning higher contribution to a parameter that contributes to a higher marriage score as a result of the marriage score simulation. In the example depicted in FIG. 22, not only the changed values of the profile proposed each as an improvement but also the degree of influence (contribution) of the improvement to the marriage score is presented to the user. This enables the user to prioritize his or her improvements.

As described above, according to this exemplary embodiment, goal setting can be made by presenting what the member currently lacks for matching with a desired partner or presenting information about the details of the change, the contribution, etc. Moreover, according to this exemplary embodiment, in the case where the marriage rate can be increased by changing part of the desired condition, the change of the desired condition is proposed to enhance the possibility of achieving the predetermined purpose (marriage).

Moreover, according to this exemplary embodiment, matching or marriage rate prediction (result-based score calculation) can be performed even with the use of free descriptive text. With the method of selecting a candidate using only the matching between a desired condition and user information, there is a possibility that the requirements of both members do not match accurately or they are actually not compatible with each other. Information input as desired conditions tends to be in the form of choice such as age, education, and annual income, and a profile written in text or the like is visually checked by a person in charge to determine whether or not the profile matches the condition. According to this exemplary embodiment, on the other hand, partner candidate automatic selection that reflects information of persons or things and matching (marriage rate) between information of persons or things can be performed using text, too. In addition, the effect of changing at least a part of the information of one or both parties in the combined information can be simulated and the simulation result can be fed back to the user.

Note that the structure described above is merely an example. For instance, in the case of not specifically selecting a partner subjected to simulation, i.e. in the case of performing simulation in a round-robin method, the desired condition storage unit 21, the first data processing unit 22, the first learning unit 24, the matching result storage unit 23, the matching learning model storage unit 25, the matching score estimation unit 26, and the first estimation result storage unit 27 may be omitted.

Moreover, the user vector or the desired condition vector may be directly used for learning or prediction (score estimation), without undergoing feature extraction.

Moreover, depending on the calculation result of the marriage score of the user inputting the desired condition and the member whose matching score is high in order, the calculation result for the combination of the current user information may be simply displayed without performing simulation. For example, the simulation step may be omitted in the case where the average marriage score with the members whose matching scores are high in order is a predetermined value or more.

Regarding the parameter change, although the above describes an example where the system changes the user information in a round-robin method and searches for the parameter corresponding to the maximum marriage rate, the user may be allowed to designate a changeable part. In this case, a parameter change GUI unit which receives, from the user, designation of an item subjected to the parameter change simulation may be added to the above-mentioned structure.

The matching rate (matching score) changes as a result of the parameter change. Here, displaying the ranking of matching to a partner enables the member to recognize his or her relative position in the ranking. This enhances the member's motivation for improvement. In such a case, a matching ranking calculation unit which calculates the matching ranking and an output unit which outputs the matching ranking may be added to the above-mentioned structure.

Typically, a large amount of member data stored in a marriage agency or the like includes not only the personal information of each member but also the information about the condition desired of a partner, the past marriage results, etc. By utilizing these data, the automatic selection of a partner who meets the desired conditions, the simulation of a marriage rate with a member who meets the condition to some extent, and the like can be realized without involving manpower.

In the matching service described in PTL 1 or PTL 2, the marriage rate may not be high even in the case where the desired conditions of both members match. There is also a possibility that the marriage rate is improved by changing part of the attribute or condition. However, introducing someone who does not match the desired condition, advising the user to change his or her attribute or condition, etc. rely on human empirical knowledge. Subjective advice based on human empirical knowledge lacks foundation. For a more effective matching service, it is preferable to give advice based on objective data.

The present invention can realize a more effective matching service.

Although the above describes an example of performing the matching of members who use a marriage counseling service and the simulation of marriage rate resulting from a change of the personal information (including the desired condition) of any of the members subjected to the matching, the present invention is applicable not only to a combination of individuals or a combination of things, but also to a combination of an individual and an organization or a combination of an individual and a thing. As an example, the present invention may be used for each combination of a job seeker and a company in job hunting, where the job seeker can be presented with what the job seeker currently lacks for his or her desired company, another company that is likely to employ the current job seeker, etc. As another example, the present invention may be used for each combination of an employee and a superior, a project team, or an organization in a coordinated activity, where any skill or talent the current employee or the organization side (superior, project team, or organization) lacks can be extracted to train or move the employee or reform the organization.

The present invention is preferably used not only to improve the success rate for a predetermined purpose associated with the compatibility of persons, things, and the like, but also to improve the component rate for a predetermined purpose in any kind of combination such as between a person and a thing or between a person and an organization, to set a goal for such an improvement or enhance motivation, and the like.

The whole or part of the exemplary embodiments disclosed above can be described as, but not limited to, the following supplementary notes.

(Supplementary Note 1)

An information processing device comprising: a relation information storage unit which stores information indicating relations, each being a relation between a success rate of accomplishing an aimed purpose by a pair of persons or things and attributes of each of the persons or things; and a proposal unit which proposes to change at least some of attributes of at least one of persons or things composing a new pair, based on the information stored in the relation information storage unit.

(Supplementary Note 2)

The information processing device according to supplementary note 1, wherein the proposal unit presents, as a proposal of a change, a change of at least one attribute included in the attributes of the at least one of the pair and the modified success rate estimated based on the information stored in the relation information storage unit.

(Supplementary Note 3)

The information processing device according to supplementary note 1, wherein the proposal unit proposes the change for improving the success rate of the pair of a first user and a second user who meets a condition designated by the first user, the change being a change of at least some of attributes of the first user.

(Supplementary Note 4)

The information processing device according to supplementary note 1, wherein the proposal unit proposes the change for improving the success rate of the pair of a first user and a second user, the change being a change of at least one attribute that is included in the attributes of the second user and matches a condition designated by the first user.

(Supplementary Note 5)

The information processing device according to supplementary note 1, wherein the proposal unit proposes the change for improving the success rate of the new pair, the change being a change of at least one attribute that is included in the attributes of the at least one of the pair and designated as a changeable attribute.

(Supplementary Note 6)

The information processing device according to supplementary note 1, wherein the proposal unit includes: a success rate estimation unit which, when a set of attributes is input, estimates the success rate of accomplishing the purpose resulted from the set of attributes, based on the input set of attributes and the information stored in the relation information storage unit; a simulation unit which, upon receiving designation of a pair of specific persons or things, changes at least some of attributes of at least one of the persons or things of the designated pair, to analyze changed success rates associated with the change of the attributes; and an analysis unit which identifies, based on analysis by the simulation unit, one or more attributes to be changed among the set of attributes, modified attribute or attributes, or a contribution of the change to improvement of the success rate, which improves the success rate of the designated pair.

(Supplementary Note 7) The information processing device according to supplementary note 6, wherein the simulation unit determines a plurality of success rates regarding respective pairs, the device further comprising a candidate selection unit which, based on a desired condition designated by a first person or thing for attribute of a second person or thing, decreases a number of pairs for which the changed success rate are determined respectively.

(Supplementary Note 8)

An information processing device comprising: a relation information storage unit which stores information indicating relations, each being a relation between a success rate of accomplishing an aimed purpose by a pair of persons or things and attributes of each of the persons or things; a success rate estimation unit which, when a set of attributes is input, estimates the success rate of accomplishing the purpose resulted from the set of attributes, based on the input set of attributes and the information stored in the relation information storage unit; a simulation unit which, upon receiving designation of a pair of specific persons or things, changes at least some of attributes of at least one of the persons or things of the designated pair, to analyze changed success rates associated with the change of the attributes; and a display unit which displays at least: a result of analysis by the simulation unit; and/or modified attribute or attributes among the set of attributes or a contribution of the change to improvement of the success rate identified by the result, which improves the success rate of the designated pair.

(Supplementary Note 9)

The information processing device according to supplementary note 1, further comprising a learning unit which machine-learns the relations, each being a relation between the success rate of accomplishing an aimed purpose by any pair of persons or things and attributes of each of the persons or things, using, as learning data, a set of attributes of persons or things of each pair for which a success or failure of the purpose is determinable.

(Supplementary Note 10)

A success support system comprising: a learning unit which machine-learns relations, each being a relation between a success rate of accomplishing an aimed purpose by any pair of persons or things and attributes of each of the persons or things, using, as learning data, a set of attributes of persons or things of each pair for which a success or failure of the purpose is determinable; a simulation unit which, upon receiving designation of a pair of specific persons or things, analyzes changed the success rates while changing at least some of attributes of at least one of the persons or things of the designated pair, using a result of the learning by the learning unit; and a display unit which displays at least: a result of analysis by the simulation unit; and/or modified attribute or attributes among the set of attributes or a contribution of the change to improvement of the success rate identified by the result, which improves the success rate of the designated pair.

(Supplementary Note 11)

A success support method comprising proposing, by an information processing device, based on information that is stored in a predetermined storage unit and indicates relations, each being a relation between a success rate of accomplishing an aimed purpose of persons or things and attributes of each of the persons or things, a change of at least some of attributes of at least one of persons or things.

(Supplementary Note 12)

A non-transitory computer-readable recording medium having recorded thereon a success support program for causing a computer to execute a process of proposing, based on information that is stored in a predetermined storage unit and indicates relations, each being a relation between a success rate of accomplishing an aimed purpose of persons or things and attributes of each of the persons or things, a change of at least some of attributes of at least one of persons or things.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing device comprising:
a relation information storage unit which stores information indicating relations, each being a relation between a success rate of accomplishing an aimed purpose by a pair of persons or things and attributes of each of the persons or things; and
a proposal unit which proposes to change at least some of attributes of at least one of persons or things composing a new pair, based on the information stored in the relation information storage unit.

2. The information processing device according to claim 1, wherein the proposal unit presents, as a proposal of a change, a change of at least one attribute included in the attributes of the at least one of the pair and the modified success rate estimated based on the information stored in the relation information storage unit.

3. The information processing device according to claim 1, wherein the proposal unit proposes the change for improving the success rate of the pair of a first user and a second user who meets a condition designated by the first user, the change being a change of at least some of attributes of the first user.

4. The information processing device according to claim 1, wherein the proposal unit proposes the change for improving the success rate of the pair of a first user and a second user, the change being a change of at least one attribute that is included in the attributes of the second user and matches a condition designated by the first user.

5. The information processing device according to claim 1, wherein the proposal unit proposes the change for improving the success rate of the new pair, the change being a change of at least one attribute that is included in the attributes of the at least one of the pair and designated as a changeable attribute.

6. The information processing device according to claim 1, wherein the proposal unit includes:
a success rate estimation unit which, when a set of attributes is input, estimates the success rate of accomplishing the purpose resulted from the set of attributes, based on the input set of attributes and the information stored in the relation information storage unit;
a simulation unit which, upon receiving designation of a pair of specific persons or things, changes at least some of attributes of at least one of the persons or things of the designated pair, to analyze changed success rates associated with the change of the attributes; and
an analysis unit which identifies, based on analysis by the simulation unit, one or more attributes to be changed among the set of attributes, modified attribute or attributes, or a contribution of the change to improvement of the success rate, which improves the success rate of the designated pair.

7. The information processing device according to claim 6, wherein the simulation unit determines a plurality of success rates regarding respective pairs, the device further comprising
a candidate selection unit which, based on a desired condition designated by a first person or thing for attribute of a second person or thing, decreases a number of pairs for which the changed success rate are determined respectively.

8. The information processing device according to claim 1, further comprising
a learning unit which machine-learns the relations, each being a relation between the success rate of accomplishing an aimed purpose by any pair of persons or things and attributes of each of the persons or things, using, as learning data, a set of attributes of persons or things of each pair for which a success or failure of the purpose is determinable.

9. A success support system comprising:
a learning unit which machine-learns relations, each being a relation between a success rate of accomplishing an aimed purpose by any pair of persons or things and attributes of each of the persons or things, using, as learning data, a set of attributes of persons or things of each pair for which a success or failure of the purpose is determinable;
a simulation unit which, upon receiving designation of a pair of specific persons or things, analyzes changed the success rates while changing at least some of attributes of at least one of the persons or things of the designated pair, using a result of the learning by the learning unit; and
a display unit which displays at least: a result of analysis by the simulation unit; and/or modified attribute or attributes among the set of attributes or a contribution of the change to improvement of the success rate identified by the result, which improves the success rate of the designated pair.

10. A success support method comprising
proposing, by an information processing device, based on information that is stored in a predetermined storage unit and indicates relations, each being a relation between a success rate of accomplishing an aimed purpose of persons or things and attributes of each of the persons or things, a change of at least some of attributes of at least one of persons or things.
